(19) United States
(12) Patent Application Publication
(10) Pub. No.: US 2015/0124483 A1
(43) Pub. Date: May 7, 2015

(54) BACKLIGHT ASSEMBLY AND DISPLAY APPARATUS HAVING THE SAME

(71) Applicant: Samsung Display Co., LTD, Yongin-City (KR)

(72) Inventors: Chung-Hui LEE, Cheongju-si (KR); Seung-Won KUK, Asan-si (KR); Joon-Seok AHN, Suwon-si (KR); Jee-Su PARK, Hwaseong-si (KR)

(73) Assignee: Samsung Display Co., LTD, Yongin-City (KR)

(21) Appl. No.: 14/225,680

(22) Filed: Mar. 26, 2014

(30) Foreign Application Priority Data
Nov. 4, 2013 (KR) 10-2013-0132972

(51) Int. Cl. F21V 8/00

(52) U.S. Cl. CPC G02B 6/0073
USPC 362/612; 362/97.4; 362/611

(57) ABSTRACT

A display apparatus includes a display panel configured to display an image using light, a backlight assembly including a light source unit configured to generate the light, a lower receiving container including a bottom portion covering a lower surface of the light source unit and a side wall extended from an edge of the bottom portion, and a mold frame including a transmission portion between and facing a upper surface of the light source unit and the display panel, and a supporting portion facing a side surface of the lower receiving container, and a cover member covering a side surface of the mold frame and a lower surface of the lower receiving container.

This application claims priority to Korean Patent Application No. 10-2013-0132972, filed on Nov. 4, 2013, and all the benefits accruing therefrom under 35 U.S.C. §119, the contents of which are incorporated by reference herein in their entireties.

### BACKGROUND

1. Field

Exemplary embodiments of the invention relate to a backlight assembly and a display apparatus having the backlight assembly. More particularly, exemplary embodiments of the invention relate to a backlight assembly capable of omitting a bezel and a display apparatus having the backlight assembly.

2. Description of the Related Art

Flat panel display apparatuses that can decrease a weight and a volume corresponding to the limitations of cathode ray tubes (“CRTs”) are being developed. A liquid crystal display (“LCD”), plasma display panels (“PDPs”), a field emission display (“FED”) and a light emitting diode (“LED”) display are actively being researched as flat type display apparatuses. However, among such flat display apparatuses, the LCD is relatively easily manufactured, has good drivability of drivers thereof, realizes a high-quality image, and thus attracts much attention.

In terms of technology and design interesting to consumers, research and development of flat panel display apparatuses is increasingly required. Therefore, efforts are being continuously made for minimizing thicknesses of (e.g., slimming) a display apparatus, and research is increasingly conducted on a design with an enhanced sense of beauty that can induce consumers to buy the display apparatus by appealing to the consumer's sense of beauty.

However, in design developments for enhancing a sense of beauty or slimming of a display apparatus that have been made to date, elements configuring a related art display apparatus have been applied in essentially unchanged combinations, and the structures of the elements have merely been changed. Due to these reasons, there are limitations in slimming the display apparatus and developing new designs of the display apparatus.

For example, in an LCD of the related art, a lower case and a front case are basic elements used for receiving a liquid crystal display panel and a backlight assembly. Moreover, a separate front set cover and rear set cover are additionally used for applying the LCD to notebook computers, monitors, mobile devices, television, etc. As described above, a display apparatus of the related art necessarily uses the front set cover and rear set cover as well as the lower case and front case, and consequently, there are limitations in reducing the thickness of the LCD and/or changing the design thereof

### SUMMARY

Particularly, the front set cover and rear set cover cover a top edge of a liquid crystal display panel in an LCD. Due to this reason, the thicknesses of a display apparatus inevitably become thicker, and moreover, border widths of a bezel around a display area of the display apparatus enlarge. In addition, realizing various innovative designs due to a step height in a border portion of the bezel may be difficult

One or more exemplary embodiment of the invention provides a backlight assembly capable of omitting a bezel thereof

One or more exemplary embodiment of the invention further provides a display apparatus having the backlight assembly.

According to an exemplary embodiment of the invention, a backlight assembly includes a light source unit configured to generate light, a lower receiving container configured to receive the light source unit, the lower receiving container including a bottom portion covering a lower surface of the light source unit and a side wall extended from an edge of the bottom portion, and a mold frame including a transmission portion between and facing a upper surface of the light source unit and a display panel, and a supporting portion facing a side surface of the lower receiving container.

In an exemplary embodiment, the supporting portion may have a first coloring, and the transmission portion may have a second coloring different from the first coloring.

In an exemplary embodiment, the first coloring may be black, and the second coloring may be transparency.

In an exemplary embodiment, the transmission portion may be integral with the supporting portion.

In an exemplary embodiment, the mold frame may include polymethylmethacrylate or polycarbonate.

In an exemplary embodiment, the light source unit may include a flexible printed circuit board, a light source which is on the flexible printed circuit board and generates the light, and a light guide plate guiding light from the light source to the display panel.

In an exemplary embodiment, the light source may include a light emitting diode.

In an exemplary embodiment, the light source may be adjacent to an end of the light guide plate.

According to another exemplary embodiment of the invention, a display apparatus includes a display panel configured to display an image using a light, a backlight assembly including a light source unit configured to generate the light, a lower receiving configured to receive the light source unit, the lower receiving container including a bottom portion covering a lower surface of the light source unit and a side wall extended from the bottom portion, and a mold frame including a transmission portion between and facing a upper surface of the light source unit and the display panel, and a supporting portion facing a side surface of the lower receiving container, and a cover member covering a side surface of the mold frame and a lower surface of the lower receiving container.

In an exemplary embodiment, the cover member may have an “L” shape in a cross-sectional view.

In an exemplary embodiment, the supporting portion may have a first coloring, and the transmission portion may have a second coloring different from the first coloring.

In an exemplary embodiment, the first coloring may be black, and the second color may be transparency.

In an exemplary embodiment, the transmission portion may be integral with the supporting portion.

In an exemplary embodiment, the mold frame may include polymethylmethacrylate or polycarbonate.

In an exemplary embodiment, the light source unit may include a flexible printed circuit board, a light source which is on the flexible printed circuit board generates the light, and a light guide plate guiding light from the light source to the display panel.

In an exemplary embodiment, the light source may be adjacent to an end of the light guide plate.

In an exemplary embodiment, a lower surface of the display panel and an upper surface of the mold frame may be bonded to each other via an optical clear adhesive.

In an exemplary embodiment, an upper surface of the display panel may be entirely exposed by remaining elements of the display apparatus.

In an exemplary embodiment, the display apparatus may further include a coupling member which fixes the cover member to the lower receiving container.

In an exemplary embodiment, the display apparatus may further include an insertion groove defined in the cover member and the lower receiving container, into which the coupling member extends.

According to one or more exemplary embodiment of a display apparatus, a mold frame is bonded with a display panel such as by using an optically clear adhesive such that an entire of an upper surface of the display panel is exposed and forms an uppermost surface of the display apparatus. Thus, a separate or additional top chassis for fixing a display panel within a display apparatus may be omitted.

In addition, since the separate top chassis may be omitted, a manufacturing cost of the display apparatus may be decreased and a display apparatus having substantially no bezel may be manufactured

### BRIEF DESCRIPTION OF THE DRAWINGS

The above and other advantages and features of this disclosure will become more apparent by describing in further detail exemplary embodiments thereof in conjunction with the accompanying drawings, in which:

FIG. 1 is an exploded perspective view illustrating an exemplary embodiment of a display apparatus according to the invention;

FIG. 2 is a perspective view illustrating the assembled display apparatus of FIG. 1;

FIG. 3 is a cross-sectional view taken along line I-I′ of FIG. 2;

FIG. 4 is a perspective view illustrating an exemplary embodiment of a mold frame in FIG. 1;

FIG. 5 is a cross-sectional view taken along line II-II′ of FIG. 4; and

FIG. 6 is an exploded perspective view illustrating another exemplary embodiment of display apparatus according to the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be explained in detail with reference to the accompanying drawings.

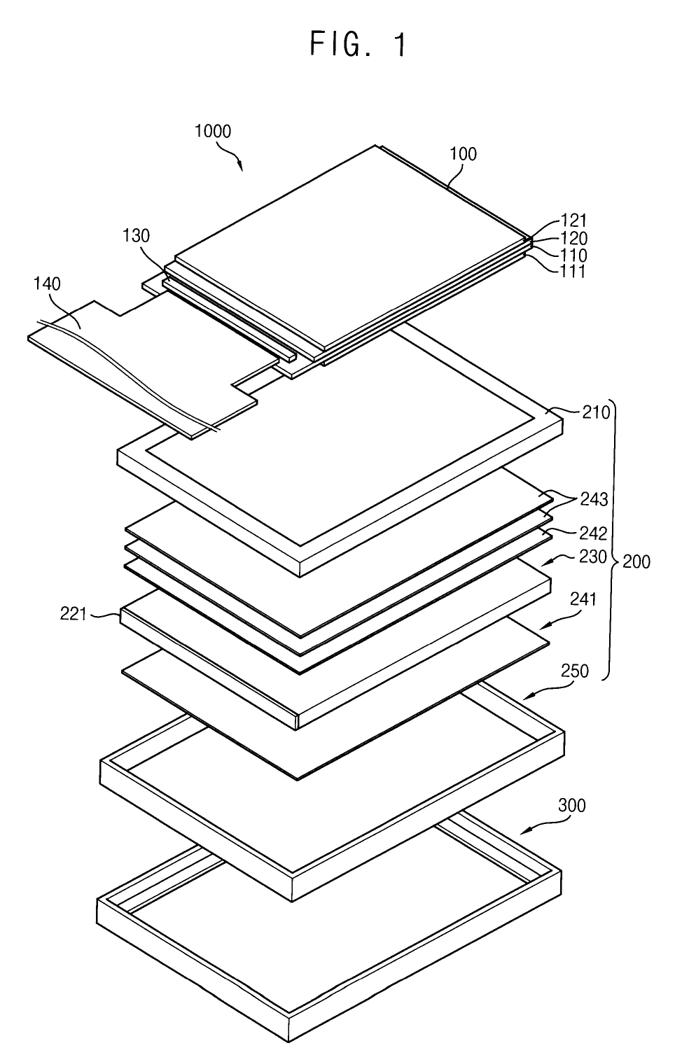

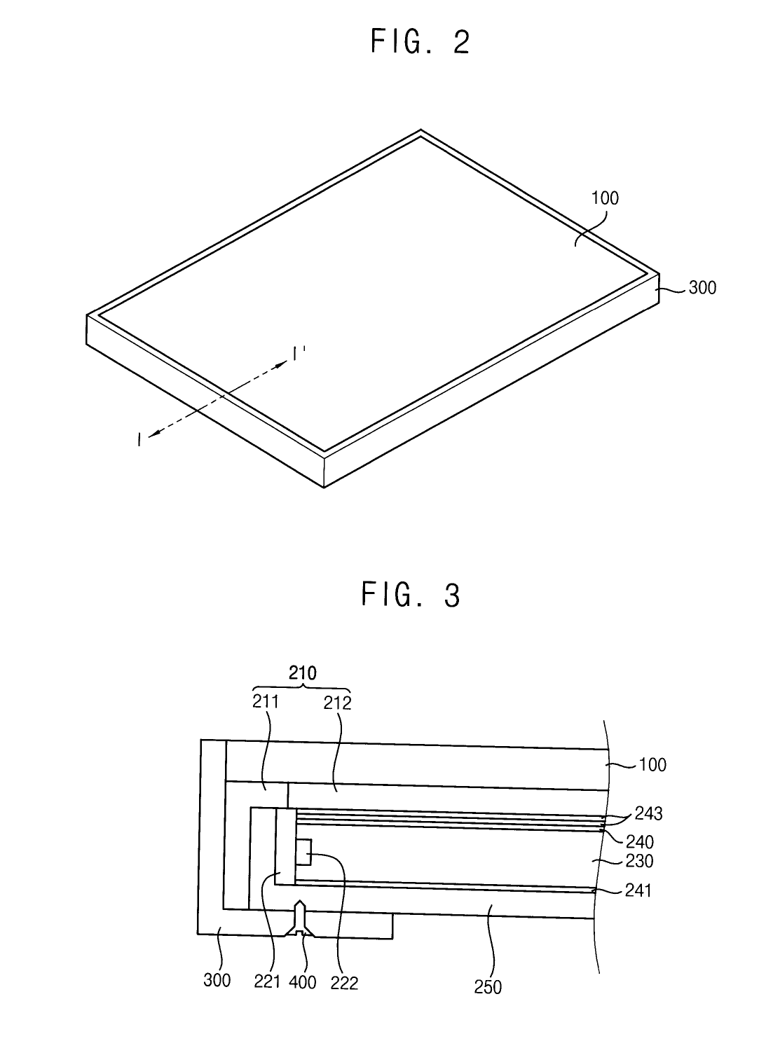

FIG. 1 is an exploded perspective view illustrating an exemplary embodiment of a display apparatus according to the invention. FIG. 2 is a perspective view illustrating the assembled display apparatus of FIG. 1. FIG. 3 is a cross-sectional view taken along line I-I′ of FIG. 2.

Referring to FIGS. 1 to 3, an exemplary embodiment of a display apparatus 1000 according to an the invention includes a display panel 100 which is configured to display an image, a main flexible printed circuit 140 physically and/or electrically connected to the display panel 100, a backlight assembly 200 configured to generate and supply light to the display panel 100, and a cover member 300.

The display panel 100 includes a first substrate 110, a second substrate 120 facing the first substrate 110, a liquid crystal layer (not shown) disposed between the first substrate 110 and the second substrate 120, a first polarizing film 111 disposed on a lower surface of the first substrate 110 and a second polarizing film 121 disposed on an upper surface of the second substrate 120. An image is displayed on the display panel 100 using a light from the backlight assembly 200.

The first substrate 110 may include a plurality of thin film transistors arranged in a matrix. A source electrode of a thin film transistor is electrically connected to a date line. A gate electrode of the thin film transistor is electrically connected to a gate line. A drain electrode of the thin film transistor is electrically connected to a pixel electrode. The pixel electrode may include transparent conductive material.

The second substrate 120 is facing the first substrate 110. The second substrate 120 may include a color filter realizing a color. The second substrate 120 may include a common electrode. The common electrode may face the pixel electrode. The common electrode may include transparent conductive material.

When a power voltage is applied to the gate electrode of the thin film transistor, the thin film transistor is turned on, and an electric field is formed between the pixel electrode and the common electrode. The electric field varies an aligning angle of liquid crystal molecules of the liquid crystal layer disposed between the first substrate 110 and the second substrate 120. Thus, a light transmittance of the liquid crystal layer is varied in accordance with the variation of the aligning angle of the liquid crystals, so a desired image may be obtained.

The first polarizing film 111 may be disposed on the lower surface of the first substrate 110. The first polarizing film 111 may have a first polarization axis. The first polarizing film 111 may polarize light in a first direction.

The second polarizing film 121 may be disposed on the upper surface of the second substrate 120. The second polarizing film 121 may have a second polarization axis. The second polarizing film 121 may polarize light in a second direction crossing the first direction. In an exemplary embodiment, for example, the first polarization axis may be crossed or inclined with respect to the second polarization axis.

The display panel 100 may further include a driving chip 130. The driving chip 130 may drive the first substrate 110. The driving chip 130 is configured to generate a driving signal which drives the first substrate 110 in response to a control signal applied from other elements (not shown). In the illustrated exemplary embodiment, the driving chip 130 may be disposed at an end of the first substrate 110, of which a portion is exposed by the second substrate 120 at such end. In an exemplary embodiment, for example, the driving chip 130 may be physically and/or electrically connected to the first substrate 110 by a chip on glass process.

The main flexible printed circuit 140 is electrically connected to an end of the first substrate 110 to apply a control signal to the display panel 100. The main flexible printed circuit 140 may be electrically connected to the same end of the first substrate 110 to which the driving chip is connected 130. In an exemplary embodiment, for example, the main flexible printed circuit 140 may be physically and/or electrically connected to the first substrate 110 by a chip on glass process. In the illustrated exemplary embodiment, the main flexible printed circuit 140 is connected to the end of the first substrate 110 and is bent to be disposed at a lower surface of the display panel 100. In an exemplary embodiment, for example, the main flexible printed circuit 140 may include a resin having flexibility.

The backlight assembly 200 is disposed under the display panel 100. The backlight assembly 200 includes a light source unit which is configured to generate light, a lower receiving container 250 configured to receive the light source unit, and a mold frame 210 disposed over the lower receiving container 250 and configured to cover an outside of the lower receiving container 250.

The light source unit may include a flexible printed circuit board 221, a light source 222, a light guide plate 230 and a plurality of optical sheets.

The flexible printed circuit board 221 may provide the light source 222 disposed thereon, with driving power. In the illustrated exemplary embodiment, the flexible printed circuit board 221 may be disposed under the first substrate 110 in a cross-section thickness direction, to correspond to an end of the display panel 100. In an exemplary embodiment, for example, the flexible printed circuit board 221 may include a resin having flexibility. The flexible printed circuit board 221 may include a metal line or conductive circuit (not shown) disposed thereon.

The light source 222 is disposed on the flexible printed circuit board 221 and generates light. In the illustrated exemplary embodiment, the light source 222 may be mounted on the flexible printed circuit board 221. In an exemplary embodiment, for example, the light source 222 may include a light emitting diode (“LED”) emitting a white light. A number of light sources 222 may be determined in consideration of a size and brightness of the display panel 100. In the illustrated exemplary embodiment, the flexible printed circuit board 221 and the light source 222 may be disposed at an end of the light guide plate 230.

The light guide plate 230 may be disposed under the display panel 100 in the cross-section thickness direction. The light guide plate 230 may have a plate shape. The light guide plate 230 may be disposed adjacent to the light source 222 to face a light exit surface of the light source 222. A groove may be defined in the light guide plate 230. The light source 222 may be disposed in the groove, so that a loss of light may be decreased. The light guide plate 230 guides light emitted from the light source 222 toward the display panel 100.

The light guide plate 230 includes a transparent material to minimize a loss of light from the light source 222. In an exemplary embodiment, for example, the light guide plate 230 may include a material having superior strength, such as polymethylmethacrylate (“PMMA”).

In order to reduce a cross-sectional thickness of the light guide plate 230, the light guide plate 230 may include polycarbonate (“PC”). The PC is inferior in strength to the PMMA, but the PC is superior in heat-resistance to the PMMA.

The optical sheets may improve luminance characteristics of light emitted from the light guide plate 230. The optical sheets may include a reflecting sheet 241, a diffusion sheet 242 and a prism sheet 243.

The reflecting sheet 241 may be disposed under the light guide plate 230 in the cross-section thickness direction. The reflecting sheet 241 reflects light leaked through a lower surface of the light guide plate 230 back to the light guide plate 230, so that light efficiency is enhanced.

The diffusion sheet 242 may be disposed on (e.g., above) the light guide plate 230. The diffusion sheet 242 may diffuse light exiting from the light guide plate 230.

The prism sheet 243 may be disposed on the diffusion sheet 242. The prism sheet 243 may condense light exiting from the light guide plate 230. In an exemplary embodiment, for example, the prism sheet 243 may include a vertical prism sheet condensing light in a vertical direction and/or a horizontal prism sheet condensing light in a horizontal direction.

The mold frame 210 may cover an outside of the light source unit and expose a lower surface of the light source unit. That is, the mold frame 210 may overlap an entire of external surfaces of the light source unit, except for the lower surface thereof. The mold frame 210 may be engaged with the display panel 100 disposed over the light source unit. The mold frame 210 may have a substantially frame shape. The mold frame 210 may include a material which can be confirmed to an adjacent structure, such as material capable of being melted. In an exemplary embodiment, for example, the mold frame 210 may include a material having superior strength, such as PMMA.

In order to reduce a thickness of portions of the mold frame 210, the mold frame 210 may include PC. The PC is inferior in strength to the PMMA, but the PC is superior in heat-resistance to the PMMA.

The mold frame 210 may include a supporting portion 211 and a transmission portion 212. Light exiting from the light guide plate 230 passes through the transmission portion 212 to be provided to the display panel 100. The supporting portion 211 may have a first coloring. The transmission portion 212 may have a second coloring different from the first coloring. The second coloring may be considered as having no color or substantially absent of color, such that light passes therethrough. In an exemplary embodiment, for example, the supporting portion 211 may have a black color, which blocks and/or absorbs light. The transmission portion 212 may be transparent (e.g., substantially absent of color).

The supporting portion 211 may be integral with the transmission portion 212. In an exemplary embodiment of a method of forming a light source unit, the mold frame 210 may be formed using an insert injection molding process. The mold frame 210 may be formed in a double injection molding process. The mold frame 210 is formed in a double injection molding process, so that the supporting portion 211 may be formed as black color and the transmission portion 212 may be formed transparent.

The lower receiving container 250 may receive the light source unit. The lower receiving container 250 may include a metal material having a superior strength. In an exemplary embodiment, for example, the lower receiving container 250 may be a chassis formed of a metal material. The lower receiving container 250 includes a bottom portion, and a side wall extended from an edge of the bottom portion.

An insertion groove may be defined in a lower surface of the lower receiving container 250. The insertion groove may extend from the lower surface of the lower receiving container 250 and extend partially or completely through a thickness thereof at the lower surface. A coupling member 400 may be inserted into the insertion groove to fix the cover member 300 with respect to the lower receiving container 250. The mold frame 210 may cover an outside of the lower receiving container 250. The mold frame 210 may cover an outside of the lower receiving container 250 and expose a lower surface of the lower receiving container 250. That is, the mold frame 210 may overlap an entire of external surfaces of the lower receiving container 250, except for the lower surface thereof

The display panel 100 may be disposed on the mold frame 210. A lower surface of the display panel 100 may be bonded with an upper surface of the mold frame 210 such as by using an adhesive. In an exemplary embodiment, for example, the lower surface of the display panel 100 may be bonded with the upper surface of the mold frame 210 using an optically clear adhesive. The transmission portion 212 of the mold frame 210 may be transparent. Thus, light exiting from the light guide plate 230 may pass through the transmission portion 212 to be provided to the display panel 100.

No further element of the display apparatus 1000 is disposed on an upper surface of the display panel 100. Thus, the upper surface of the display panel 100 may be entirely exposed. One or more exemplary embodiment of a display apparatus according to the invention may omit an additional or separate element such as top chassis, so that a display panel of the display apparatus may be entirely exposed by remaining elements of the display apparatus 1000. The exposed upper surface of the display panel 100 may define a display surface of the display apparatus 1000, such that an entire of the display surface of the display apparatus 1000 is exposed to outside the display apparatus 1000.

The cover member 300 may cover the backlight assembly 200 bonded with the display panel 100. The cover member 300 may cover an outside of the mold frame 210 and a portion of the lower receiving container 250, and expose a portion of a lower surface of the lower receiving container 250. In an exemplary embodiment, for example, the cover member 300 may have a frame shape. The cover member 300 may have an “L” shape in a cross-sectional view.

The cover member 300 may be fixed to the lower receiving container 250 by the coupling member 400. An insertion groove may be defined in a lower surface of the lower receiving container 250. The coupling member 400 may be inserted into the insertion groove to fix the cover member 300 to the lower receiving container 250. An insertion groove defined in a lower surface of the cover member 300 may correspond to the insertion groove defined in the lower surface of the lower receiving container 250. In an exemplary embodiment, for example, the coupling member 400 may be a screw. Thus, the coupling member 400 may be inserted into the insertion groove defined in the lower surface of the cover member 300 and the insertion groove defined in the lower surface of the lower receiving container 250, to fix a cover member 300 to the lower receiving container.

The cover member 300 covers an outside of the mold frame 210 and a portion of the lower receiving container 250. An upper surface of the display panel 100 is not covered by the cover member 300. Thus, the upper surface of the display panel 100 may be entirely exposed.

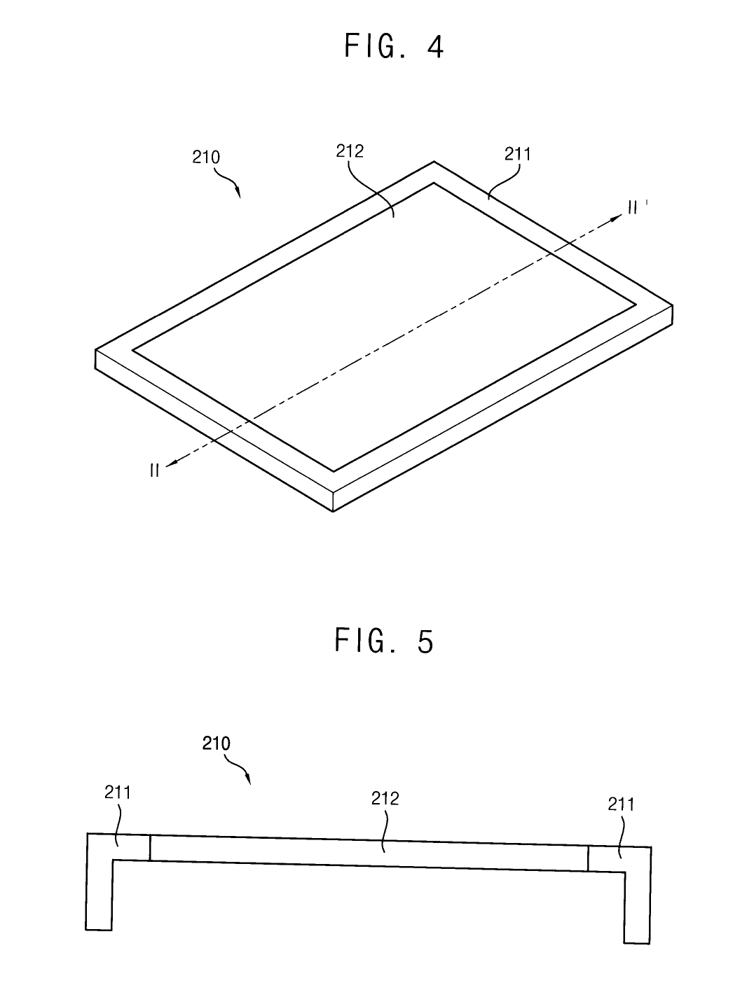

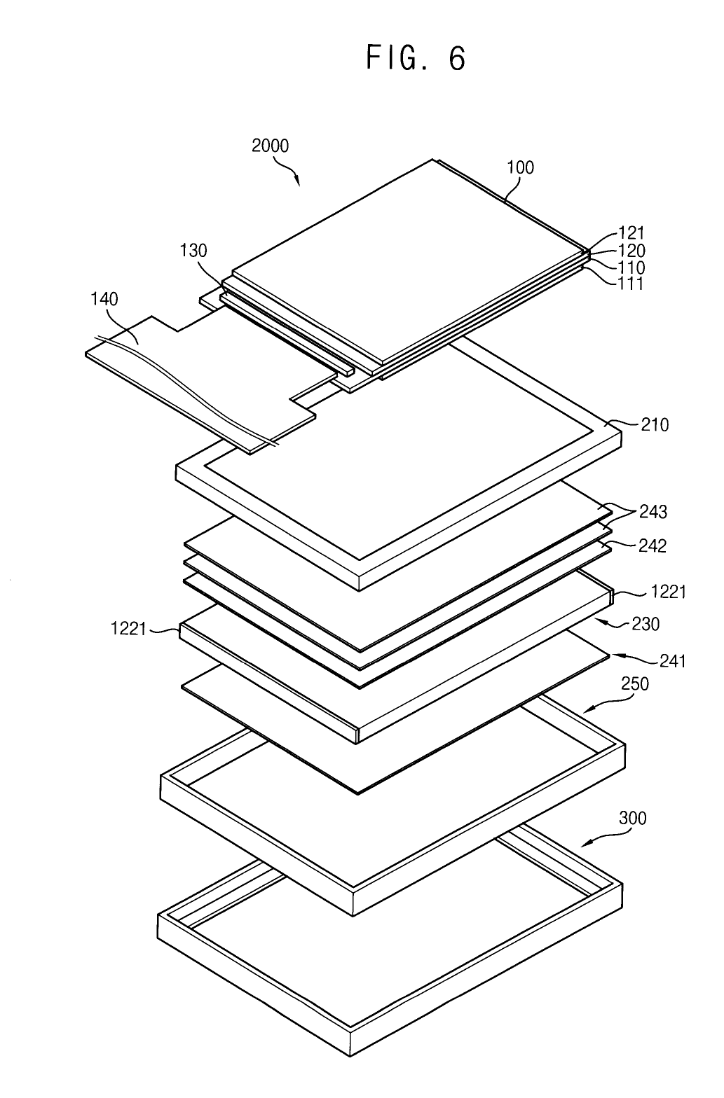

FIG. 4 is a perspective view illustrating an exemplary embodiment of a mold frame in FIG. 1. FIG. 5 is a cross-sectional view taken along line II-II′ of FIG. 4.

Referring to FIGS. 4 and 5, an exemplary embodiment of a mold frame 210 according to the invention may include a supporting portion 211 and a transmission portion 212.

The supporting portion 211 is configured to support the display panel 100. Light exiting from the light guide plate 230 passes through the transmission portion 212 to be provided to the display panel 100 thereabove. The supporting portion 211 may have a first coloring. The transmission portion 212 may have a second coloring different from the first coloring. In an exemplary embodiment, for example, the supporting portion 211 may have a black color. The transmission portion 212 may be transparent.

The supporting portion 211 may be integral with the transmission portion 212. In an exemplary embodiment of a method of forming a light source unit, the mold frame 210 may be formed using an insert injection molding process. The mold frame 210 may be formed in a double injection molding process. The mold frame 210 is formed in a double injection molding process, so that the supporting portion 211 may be formed as black color and the transmission portion 212 may be formed as transparent.

The mold frame 210 may cover an outside of the light source unit and expose a lower surface of the light source unit. The mold frame 210 may be engaged with the display panel 100 disposed over the light source unit. The mold frame 210 may have a frame shape. The mold frame 210 may include a material capable of melting or substantially confirming to an adjacent structure. In an exemplary embodiment, for example, the mold frame 210 may include a material having superior strength, such as PMMA.

In order to reduce a thickness of the mold frame 210, portions of the mold frame 210 may include PC. The PC is inferior in strength to the PMMA, but the PC is superior in heat-resistance to the PMMA.

A lower surface of the display panel 100 may be bonded with an upper surface of the mold frame 210 such as by using an adhesive. In an exemplary embodiment, for example, the lower surface of the display panel 100 may be bonded with the upper surface of the mold frame 210 using an optically clear adhesive. The transmission portion 212 of the mold frame 210 may be transparent. Thus, light exiting from the light guide plate 230 may pass through the transmission portion 212 to be provided to the display panel 100.

FIG. 6 is an exploded perspective view illustrating another exemplary embodiment of display apparatus according to the invention.

An exemplary embodiment of a display apparatus in FIG. 6 is substantially the same as the display apparatus according to the previous exemplary embodiment of FIG. 1 except for a flexible printed circuit board and a light source, and thus the same reference numerals will be used to refer to the same or like parts as those described in the previous exemplary embodiment of FIG. 1 and any repetitive explanation concerning the above elements will be omitted.

Referring to FIG. 6, an exemplary embodiment of a display apparatus 2000 according to the invention includes a display panel 100 which is configured to display an image, a main flexible printed circuit 140 physically and/or electrically connected to the display panel 100, a backlight assembly 200 configured to supply light to the display panel 100, and a cover member 300.

The backlight assembly 200 is disposed under the display panel 100. The backlight assembly 200 includes a light source unit which is configured to generate light, a lower receiving container 250 configured to receive the light source unit, and a mold frame 210 disposed over the lower receiving container 250 and configured to cover an outside of the lower receiving container 250.

The light source unit may include a flexible printed circuit board 1221, a light source, a light guide plate 230 and a plurality of optical sheets.

The flexible printed circuit board 1221 may provide the light source disposed thereon with driving power. In the illustrated exemplary embodiment, the flexible printed circuit board 1221 may be disposed under the first substrate 110 to correspond to an end of the display panel 100. In an exemplary embodiment, for example, the flexible printed circuit board 1221 may include a resin having flexibility. The flexible printed circuit board 1221 may include a metal line or a conductive circuit (not shown) disposed thereon.

The light source is disposed on the flexible printed circuit board 1221 and generates light. In the illustrated exemplary embodiment, the light source may be mounted on the flexible printed circuit board 1221. In an exemplary embodiment, for example, the light source may include a LED emitting a white light. A number of light sources may be determined in consideration of a size and brightness of the display panel 100. In the illustrated exemplary embodiment, the flexible printed circuit board 1221 and the light source may be disposed at opposing ends of the light guide plate 230. In an exemplary embodiment, for example, the flexible printed circuit board 1221 and the light source may be disposed at both short sides of the light guide plate 230.

According to one or more exemplary embodiment of a display apparatus, a mold frame is bonded with a display panel such as by using an optically clear adhesive, such that an entire of an upper surface of the display panel is exposed and forms an uppermost surface of the display apparatus. Thus, a separate or an additional top chassis for fixing a display panel within the display apparatus may be omitted.

In addition, since the separate a top chassis may be omitted, a manufacturing cost of the display apparatus may be decreased and a display apparatus having substantially no bezel may be manufactured.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifies to the disclosed exemplary embodiments, as well as other exemplary embodiments, are intended to be included within the scope of the appended claims. The invention is defined by the following claims, with equivalents of the claims to be included therein.

What is claimed is:

1. A backlight assembly comprising:
a light source unit configured to generate light;
a lower receiving container configured to receive the light source unit, comprising a bottom portion covering a lower surface of the light source unit and a side wall extended from an edge of the bottom portion; and
a mold frame comprising:
a transmission portion between and facing a upper surface of the light source unit opposite to the lower surface, and a display panel, and
a supporting portion facing a side surface of the lower receiving container.

2. The backlight assembly of claim 1, wherein
the supporting portion has a first coloring, and
the transmission portion has a second coloring different from the first coloring.

3. The backlight assembly of claim 2, wherein
the first coloring is a black color, and
the second coloring is transparency.

4. The backlight assembly of claim 3, wherein the transmission portion is integral with the supporting portion.

5. The backlight assembly of claim 1, wherein the mold frame comprises polymethylmethacrylate or polycarbonate.

6. The backlight assembly of claim 1, wherein the light source unit comprises:
a flexible printed circuit board;
a light source which is on the flexible printed circuit board and generates the light; and
a light guide plate configured to guide the light from the light source to the display panel.

7. The backlight assembly of claim 6, wherein the light source comprises a light emitting diode.

8. The backlight assembly of claim 6, wherein the light source is adjacent to an end of the light guide plate.

9. A display apparatus comprising:
a display panel configured to display an image using light;
a backlight assembly comprising:
a light source unit configured to generate the light,
a lower receiving container configured to receive the light source unit, comprising a bottom portion covering a lower surface of the light source unit and a side wall extending from an edge of the bottom portion, and
a mold frame comprising:
a transmission portion between and facing a upper surface of the light source unit and the display panel, and
a supporting portion facing a side surface of the lower receiving container; and
a cover member facing a side surface of the mold frame and a lower surface of the lower receiving container.

10. The display apparatus of claim 9, wherein the cover member has an “L” shape in a cross-sectional view.

11. The display apparatus of claim 9, wherein
the supporting portion has a first coloring, and
the transmission portion has a second coloring different from the first coloring.

12. The display apparatus of claim 11, wherein
the first coloring is black, and
the second coloring is transparency.

13. The display apparatus of claim 12, wherein the transmission portion is integral with the supporting portion.

14. The display apparatus of claim 9, wherein the mold frame comprises polymethylmethacrylate or polycarbonate.

15. The display apparatus of claim 9, wherein the light source unit comprises:
a flexible printed circuit board;
a light source which is on the flexible printed circuit board and generates the light; and
a light guide plate configured to guide the light from the light source to the display panel.

16. The display apparatus of claim 15, wherein the light source is adjacent to an end of the light guide plate.

17. The display apparatus of claim 9, wherein a lower surface of the display panel and an upper surface of the mold frame are bonded to each other via an optical clear adhesive.

18. The display apparatus of claim 9, wherein an upper surface of the display panel is entirely exposed by remaining elements of the display apparatus.

19. The display apparatus of claim 9, further comprising a coupling member fixing the cover member to the lower receiving container.

20. The display apparatus of claim 19, further comprising an insertion groove defined in the cover member and the lower receiving container, and into which the coupling member extends.
